(19) United States
(12) Patent Application Publication
(10) Pub. No.: US 2003/0223109 A1
(43) Pub. Date: Dec. 4, 2003

(54) Apparatus for diopter adjustment of microscopes

(76) Inventors: Jacques Alain Deverin, Widnau (CH); Ana Lina Lopes Deverin, Widnau (CH)

Correspondence Address: HODGSON RUSS LLP, ONE M & T PLAZA, SUITE 2000, BUFFALO, NY, 14203-2391, US

(21) Appl. No.: 10/447,563

(22) Filed: May 29, 2003

(30) Foreign Application Priority Data
Jun. 4, 2002 (DE) 102 24 628.9

(51) Int. Cl. G02B 21/00; G02B 21/06

(52) U.S. Cl. 359/389; 359/368; 359/385

(57) ABSTRACT

A microscope includes an apparatus for superimposing a focusing mark image (3a) in a main beam path for assisting an observer in adjusting an eyepiece of the microscope (1) to correct for vision defects. The superimposition apparatus can be put into operation only as necessary, thereby preventing accommodation by the observer's eye. This invention relates preferably to a surgical microscope having a diopter adjustment system.

### CROSS REFERENCE TO RELATED APPLICATION

This application claims priority to German patent application 102 24 628.9, filed on Jun. 4, 2002, which is incorporated by reference herein.

### FIELD OF THE INVENTION

The invention concerns a superimposition apparatus for diopter adjustment in microscopes, in particular for eyepieces in a surgical microscope. BACKGROUND OF THE INVENTION

Eyepieces are usually equipped with a diopter adjustment system so that even observers with a vision defect can see clearly without fatigue over a long period of time. The necessary adjustment can be performed fundamentally in two different ways: Either the eyepiece is adjusted with a knowledge of the observer's diopter value, or the observer adjusts the eyepiece, while looking through it, so that he or she sees clearly. With the first variant, it is disadvantageous that the vision defect is unknown in the context of the preadjustment.

In the existing art, so-called focusing lines or crosshairs are used to improve this situation. These crosshairs, applied to so-called reticles, are normally arranged in the plane of the intermediate image.

When an observer having a severe vision defect looks through the eyepiece, the “personal” visual plane in which he or she sees clearly very probably lies outside the region in which the tube lens of the microscope generates the object image (=so-called intermediate image of the microscope). That forces the observer to adjust his or her visual plane by means of the eyepiece so that it ends up within that region. Ideally, this should be the case no matter where the reticle with the crosshairs is located, since this plane corresponds to the zero setting of the microscope. It is possible in this context, however, that the observer can already see the object image clearly, but only because his or her eye has accommodated to the image of the crosshairs. The consequence of this, in turn, is that the observer believes that his or her visual image and the intermediate image of the microscope should coincide; but if it does not coincide, because of an accommodation process of the eye to the crosshairs image (i.e. the location where the optimum intermediate image is equal to the zero position of the microscope), the observer does see clearly but additional outputs—for example for cameras, assistants, or the like—are provided with an unsharp image. That in turn requires separate fine-focusing operations at those outputs. This is a considerable disadvantage in terms of both technology and cost. In addition, the eye's accommodation process can result in a strain on the user's visual apparatus.

A further disadvantage of existing approaches, in which crosshairs are generated by means of a reticle, is the continuous visibility of the crosshairs. The reason is that as soon as the adjustment of the microscope has been made, no further adjustments should be necessary, and the crosshairs therefore simply interfere with unimpeded, viewing of the object.

### SUMMARY OF THE INVENTION

It is the object of the present invention to eliminate these disadvantages.

The inventor has recognized that these disadvantages can be removed by making available a different aid for diopter compensation. This object is therefore achieved in that the reticle is removed from the location where the intermediate image is generated, and an image of a focusing mark (i.e. crosshairs) is briefly superimposed, by means of a light source, at said location.

The brief superimposition of the focusing mark image ensures that no accommodation of the eye to the focusing mark image can take place. That in turn ensures that the observer is given the best possible capability for checking to prevent his or her visual plane from not coinciding with the intermediate image (=zero position of the microscope=location of focusing mark image superimposition). The need for fine focusing at accessories, e.g. cameras, video devices, etc., is thus eliminated.

An optimal adjustment aid is moreover made available to the observer, and excessive eyestrain due to accommodation is thus avoided.

In order to eliminate the disadvantage of the continuous (and therefore irritating) visibility of the crosshairs or other focusing mark, the manner of achieving the present invention provides for the focusing mark image to be introduced into the observer's visual field only briefly, as necessary. This can be done in principle by manually switching a light source on and off, or also by the fact that the deflection elements are manually removed or swung away. For purposes of this invention, a “deflection element” is to be understood as any element with which light beams can be deflected. These can be, for example, mirrors, prisms, partially transparent panels, or the like.

According to the present invention, a red LED illumination system is preferred as the light source; color variants and different kinds of light sources are, however, also usable.

A further preferred embodiment of the invention provides for the superimposition of the focusing mark image to be switched on and off automatically. A wide variety of solutions for switching-on is conceivable, for example sensor-controlled solutions which switch on as soon as an observer looks through the eyepiece; or electromechanical solutions which switch on when the focusing ring of the eyepiece is moved.

Timing circuits would, for example, be conceivable for switching off the superimposition; these interrupt the delivery of power to the light source or mechanically swing away the deflection elements. Optoelectric or optoelectronic or retina-scanning variants are also a possibility in this context.

For reasons of space saving and for the simplest possible technical achievability, it is preferred in the present invention that the superimposition apparatus be mounted in the lower part of the microscope, preferably below the magnification changer and above the main objective. Also conceivable, however, are mounting locations above the magnification changer or above the accessory inputs and outputs, or also utilization of the accessory inputs themselves.

All the descriptions and depictions of the assemblages refer to implementation in a surgical stereomicroscope, and are therefore to be understood in pairs in each case. On the other hand, the invention can also be used in all other microscope variants.

### BRIEF DESCRIPTION OF THE DRAWINGS

The invention will be explained in more detail, symbolically and by way of example, with reference to the Figures. The Figures are described continuously and in overlapping fashion.

In the Figures, schematically in each case:

FIG. 1 shows a microscope comprising a superimposition apparatus according to the present invention;

FIG. 2 is the same depiction of a microscope assemblage with a different mounting location for the superimposition apparatus; and

FIG. 3 is the same schematic depiction of a microscope assemblage with a further mounting location for the superimposition apparatus.

### DETAILED DESCRIPTION OF THE INVENTION

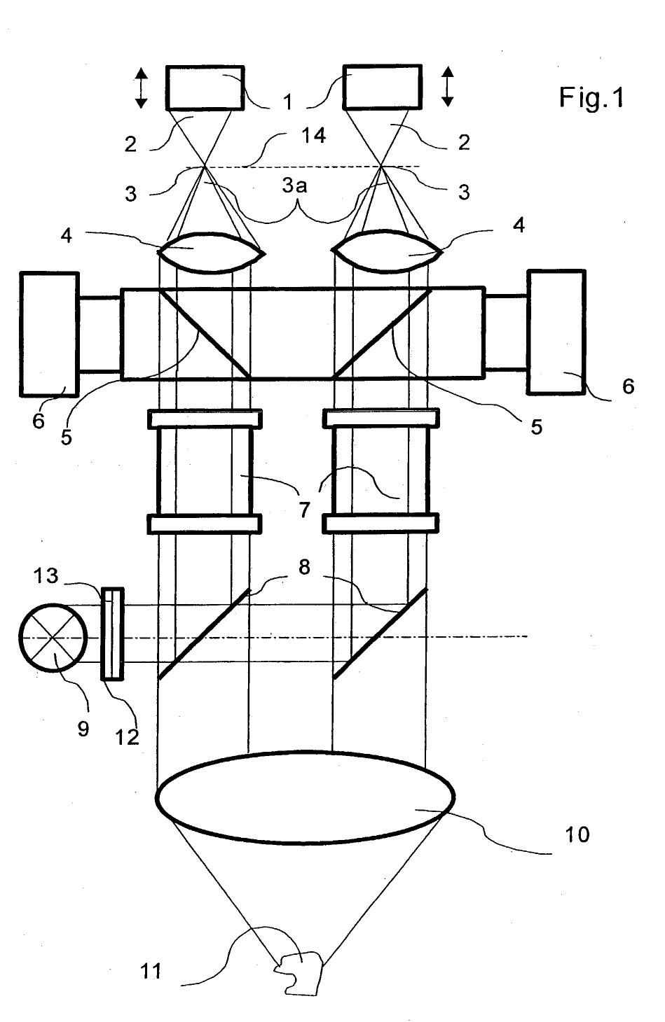

It is evident from FIG. 1 that the microscope has a binocular eyepiece, i.e. a pair, here configured adjustably, of eyepieces 1, so that visual plane 3 can be adapted to intermediate image plane 14. Intermediate image plane 14—i.e. the object image from the respective beam path 2—is generated by tube lenses 4. Superimposed image 3a is ideally also superimposed into this plane.

The microscope moreover has deflection elements 5 that supply accessory outputs 6 with light beams, or that also conversely—in the case of superimposition through (in this case) accessory inputs 6—deflect the externally obtained light beams into beam path 2. Beam paths 2 extend through magnification changers 7 and through a further deflection element 8, arranged in pairs, with which superimposition of an image of focusing mark 13 is accomplished. This is brought about by the fact that light source 9 shines through a reticle 12. The two beam paths 2 are generated by main objective 10, which is directed onto object 11 being viewed, for example a patient.

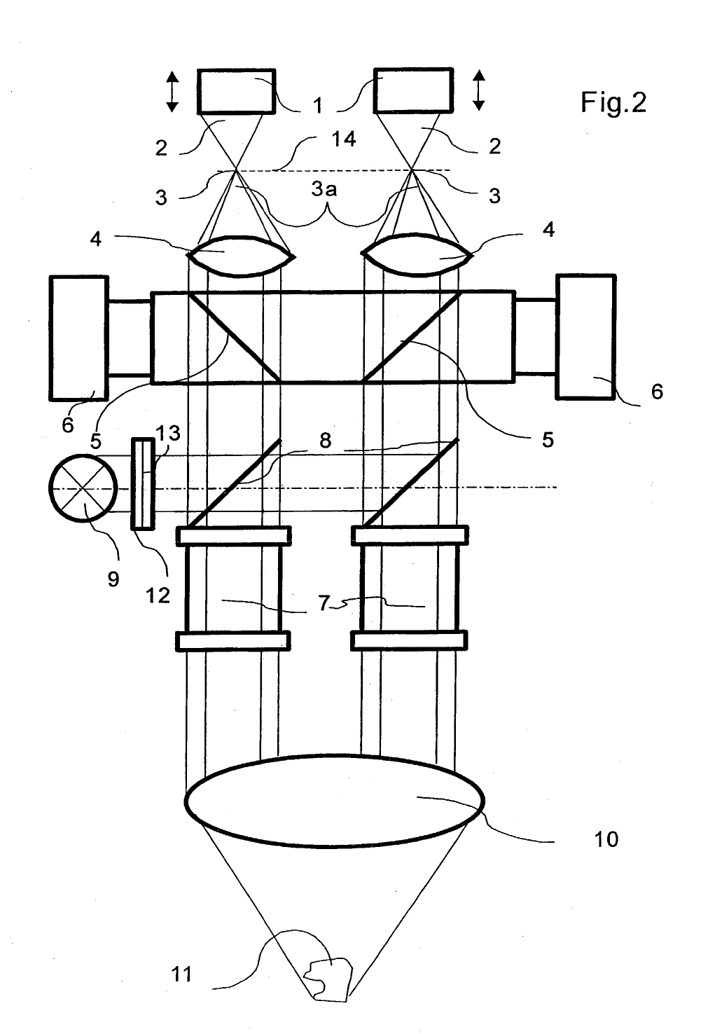

FIG. 2 depicts the same microscope assemblage, except that the apparatus for superimposing an image of focusing mark 13 by means of light source 9, reticle 12, and deflection elements 8 is mounted in a different location than in FIG. 1. In this embodiment, deflection elements 8 are located in main beam paths 2 between magnification changers 7 and deflection elements 5.

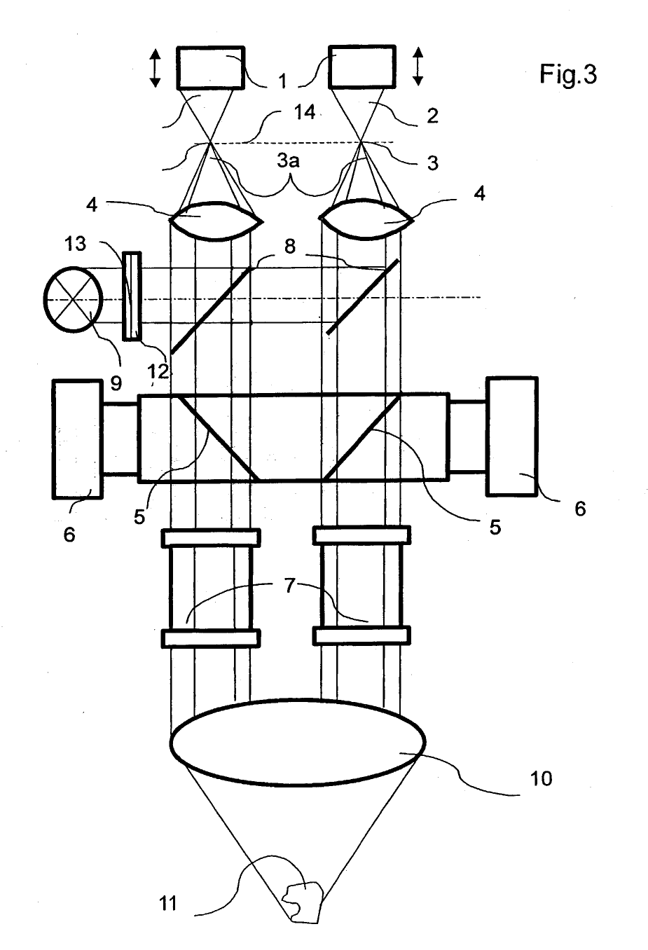

FIG. 3 depicts a further possible mounting location for the superimposition apparatus that comprises light source 9, reticle 12 with focusing mark 13, and deflection elements 8. In this embodiment, deflection elements 8 are located in main beam paths 2 between deflection elements 5 and tube lenses 4.

It is also possible to place the light source 9, and reticle 12 with focusing mark 13, in front of a deflection element 5 associated with an accessory input or output 6.

### Parts List

1 Adjustable eyepiece

2 Main beam path

3 Intermediate image of microscope (object image)/visual plane

3a Superimposed image (line image)

4 Tube lens

5 Deflection element of accessory

6 Accessory input or output

7 Magnification changer

8 Deflection element for superimposition apparatus

9 Light source

10 Main objective

11 Object

12 Reticle

13 Focusing mark

14 Intermediate image plane

What is claimed is:

1. A microscope comprising:
a main beam path;
a visual plane on said main beam path;
an intermediate image plane on said main beam path;
an adjustable eyepiece for adapting said visual plane to said intermediate image plane; and
means for superimposing a focusing mark image in said main beam path for assisting an observer in adjusting said eyepiece.

2. The microscope according to claim 1, wherein said means for superimposing a focusing mark image includes a light source, a reticle illuminated by light from said light source and having a focusing mark, and a deflection element arranged on said main beam path for redirecting light transmitted by said reticle along said main beam path.

3. The microscope as defined in claim 2, wherein said light source includes an LED.

4. The microscope as defined in claim 3, wherein said LED is color specific.

5. The microscope as defined in claim 1, wherein said means for superimposing a focusing mark image includes a video display.

6. The microscope as defined in claim 1, wherein said means for superimposing a focusing mark image is automatically activated and deactivated.

7. The microscope as defined in claim 1, further comprising an accessory input or output optically coupled to said main beam path, wherein said accessory input or output is free of focusing devices.

8. The microscope as defined in claim 2, wherein said deflection element is arranged such that said focusing mark image is superimposed in said intermediate image plane by way of said deflection element.

9. The microscope as defined in claim 2, wherein said deflection element is selected from the group consisting of a prism, a mirror, and a partially transparent element.

10. The microscope as defined in claim 2, further comprising a main objective and a magnification changer in said main beam path, wherein said deflection element is arranged between said main objective and said magnification changer.

11. The microscope as defined in claim 2, further comprising a magnification changer in said main beam path and an accessory input or output optically coupled to said main beam path, wherein said deflection element is arranged between said magnification changer and a location at which said accessory input or output is optically coupled to said main beam path.

12. The microscope as defined in claim 2, further comprising a tube lens in said main beam path and an accessory input or output optically coupled to said main beam path, wherein said deflection element is arranged between said tube lens and a location at which said accessory input or output is optically coupled to said main beam path.

13. The microscope as defined in claim 2, further comprising an accessory input or output optically coupled to said main beam path by a deflection element, and said deflection element is shared by said means for superimposing a focusing mark image in said main beam path.
